(19) United States
(12) Patent Application Publication
(10) Pub. No.: US 2005/0118383 A1
(43) Pub. Date: Jun. 2, 2005

(54) Multi-layer structure for supporting dispersed super absorbent polymeric material

(76) Inventors: Lynn E. Cargill, Mt. Clemens, MI (US); Anthony K. Stewart, Fort Wayne, IN (US); Finn Bergishagen, West Bloomfield, MI (US)

Correspondence Address: Lynn E. Cargill;Cargill & Associates, P.L.L.C., 56 Macomb Place, Mt. Clemens, MI, 48043-5636, US

(21) Appl. No.: 11/027,272

(22) Filed: Dec. 29, 2004

Related U.S. Application Data
(63) Continuation-in-part of application No. 10/147,723, filed on May 17, 2002, now abandoned.
(60) Provisional application No. 60/293,758, filed on May 25, 2001.
(60) Provisional application No. 60/556,415, filed on Mar. 25, 2004.

(51) Int. Cl. B32B 3/00; B32B 1/08; B32B 5/16; B32B 3/02; B29D 23/00

(52) U.S. Cl. 428/68; 442/415; 442/393; 428/166; 428/36.1; 428/920; 428/921

(57) ABSTRACT

A multi-layer structure containing an evenly dispersed super absorbing polymer to be used for fabric covered cooling, wetting, and fire deterrent applications. Such multi-layer structure incorporates a laminate super-absorbing polymer within various layers and pockets to maintain an even distribution of super-absorbing polymer within the fabric layers. Various applications such as cooling neckbands, fever reducing suits, house-covering fire deterrent blankets and other personal cooling devices are disclosed.

### CROSS REFERENCES TO RELATED APPLICATIONS

This Continuation-In-Part application claims the benefit under 35 U.S.C. 119(e) of U.S. Utility application Ser. No. 10/147,723 filed May 17, 2002, which claims the benefit of U.S. Provisional Application No. 60/293,758 filed on May 25, 2001, and U.S. Provisional Application No. 60/556,415 filed Mar. 25, 2004.

### TECHNICAL FIELD OF THE INVENTION

The invention relates generally to a multi-layer structure for supporting dispersed super absorbent polymeric material adapted to be used by people, animals and anything that needs to be cooled, as well as use for fire deterrence, and is especially related to a layered structured material for holding a super absorbent polymer in a particular configuration so as to allow for many applications.

### BACKGROUND OF THE INVENTION

Evaporating water next to skin is nature's way of cooling people and animals. This cooling influence on body temperature is dependent upon an endothermic reaction as liquid changes to vapor, thereby cooling the surface. In the past, water absorbent crystals, more commonly known as super absorbent polymer, has been utilized in baby diapers, feminine napkins and other materials, because the super absorbent polymer crystals (hereinafter “SAP”) are known to hold from about 20 to about 2,000 times its weight of water. Prior art attempts to utilize this for cooling an individual have included the use of the SAP for holding water against the skin.

The most common use has been a tube of fabric being somewhat filled with the dried SAP crystals, and soaking in water for approximately 15 to 20 minutes to allow the crystals to expand and fill the tube. Manual manipulation is then required in order to squish the swollen SAP crystals into place. Problems with that technology have included rashes on the necks of people who have utilized the neckband for cooling purposes due to the SAP oozing through the fabric and contacting their skin. The inventors believed that the thickened tube, after wetting, appeared as a kielbasa sausage around the neck of the wearer. Furthermore, the contact point of the “sausage” around the neck is a single point, and did not provide much cooling.

In yet another application for the materials having super absorbent polymers contained therein includes fire deterrent devices and methods. 3M Corporation of Minnesota has utilized some of the SAP technology for making fire ponchos for firemen and firefighters. In this application, it is the water holding properties of the SAP that is used to prevent fire from contacting a firefighter. Consequently, although the super absorbent polymer may also be used to deter fire damage, it also acts as a cooling material by evaporating it, as described herein above.

A prior art attempt to contact the body is embodied in U.S. Pat. No. 5,572,745 issued to Cool Wear Works of Long Beach, Calif., issued Nov. 12, 1996. This patent tries to overcome the deficiencies of the prior art by providing tubes coming in contact with the head of a person. This, however, does not address the underlying problem of holding the SAP crystals in such a configuration that many different applications may be envisioned.

Prior art attempts to wet a clothing article to deter fire can be found in the 3M Corporation fabric called “Wet Weave”. Although a patent search did not reveal issued patents, their website, cooltek.com states there are patents pending for their clothing articles and fire deterrent devices. However, these methods and devices do not address the problems and structures for solving those problems as are disclosed in the present invention.

Surgical and other medical procedures routinely leave a patient with an incision to heal over the weeks and months following a surgery. During the healing process, the incision may become itchy, painful, and may exhibit burning and other uncomfortable side effects. Conventional treatments include the use of a bandage over the incision, but this does not alleviate the itching, burning and pain. Furthermore, other medical procedures, including the use of poultices, casts, stints and other bandage type devices, further produce uncomfortable situations for itching, burning and other discomforts experienced. In an attempt to solve this problem, most hospitals and doctors cover the device with a piece of gauze and tape the gauze over the incision. Normally, there is nothing generally proposed to stop the burning, itching, and discomfort. Rather the bandage that is placed over the incision is utilized to prevent infection from attacking the incision site.

The present invention is designed to alleviate the pain, itching, swelling, and discomfort associated with surgical incisions and the healing process of those incisions. The present invention utilizes a multi-layer wet type bandage which incorporates super-absorbing polymeric materials for holding cool-to-the-touch material and moisture against the incision during the healing process. Personal experience has shown us that such a covering for an incision helps to remove the burning, itching and pain associated with the healing of such an incision. Therefore, the present invention is being promoted in order to help post-surgery recovery.

Further, as discussed more fully hereinbelow, the presently proposed personal relief device includes many other embodiments for use in the medical industry, and may also be used as a fever reducing device, a cooling device, and a relief device to be used in conjunction with casts, splints and the like.

Moreover, after the surgery, edema may occur. The present invention may be used to help reduce swelling and control edema. Further, the present invention includes an embodiment directed toward lymphedema, as usually resulting from breast cancer treatments and other edema issues on other limbs.

It is an overriding object of the present invention to hold individual SAP crystals in place for maximum cooling and wetting efficiency, whether the application is for clothing, animal coverings or for fire deterrent articles.

It is yet another object of the present invention to provide large blankets of multi-layered materials holding super absorbent polymer therebetween, to be used as blankets for homes, wraps for trees, and covers for lawns.

It is yet a further object of the present invention to provide a multi-structural device which can be used for several applications, including cooling, sweat absorption, wetting, and heating applications.

### SUMMARY OF THE INVENTION

In accordance with the above objects and advantages sought by the present invention, there is a multi-layer structure for supporting dispersed super absorbent polymeric material which achieves the objects of cooling, wetting, sweat absorption, and heating applications. The multi-layer structure includes at least an inner and an outer sheeted material, whether continuous or not, which may include, optionally, liquid pervious material sheets to prevent oozing. The super absorbent polymer is held between the inner and outer sheeted materials and may use a hydrophilic absorbent factor of between about 20 and about 10,000. This means that the super absorbent polymer can absorb from about 20 times to about 10,000 times its weight in water. Such materials are readily available from conventional sources, although specific polymers are cited hereinbelow. The choice of super absorbent polymer determines the application. A neck band may only require a 400 times hydrophilic factor, whereas the house blanket to be used as a fire deterrent would be best served by having the highest possible hydrophilic factor.

In the most general sense of the invention, the super absorbent polymer is preferably uniformly dispersed between the multi-layer structure and may be held in place by any number of means, including sewing, heat sealing into individual pockets or quilts, or by the use of adhesives to hold the SAP in place, or by using cellulose interfibers, or other fibers to hold the SAP in place. The preferred embodiments will be disclosed hereinbelow with reference to the detailed description of the invention.

### DETAILED DESCRIPTION OF THE DRAWINGS

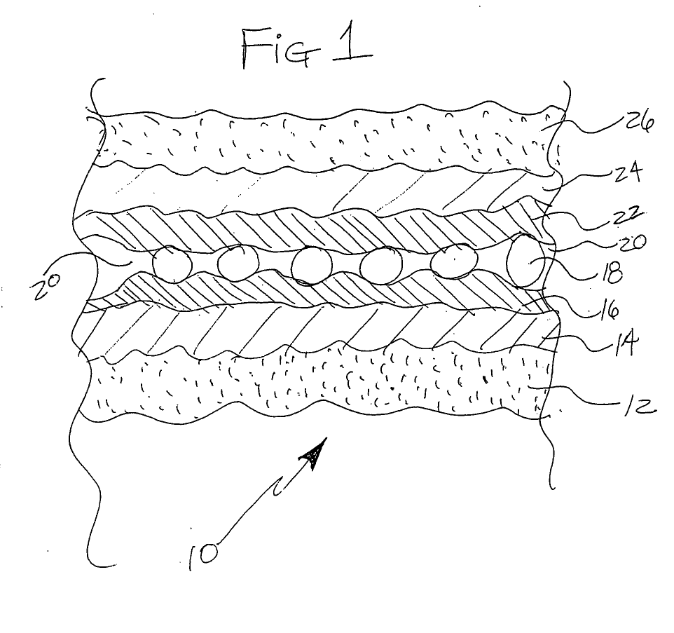

FIG. 1 is a side elevational view of a multi-layer structure in accordance with the present invention;

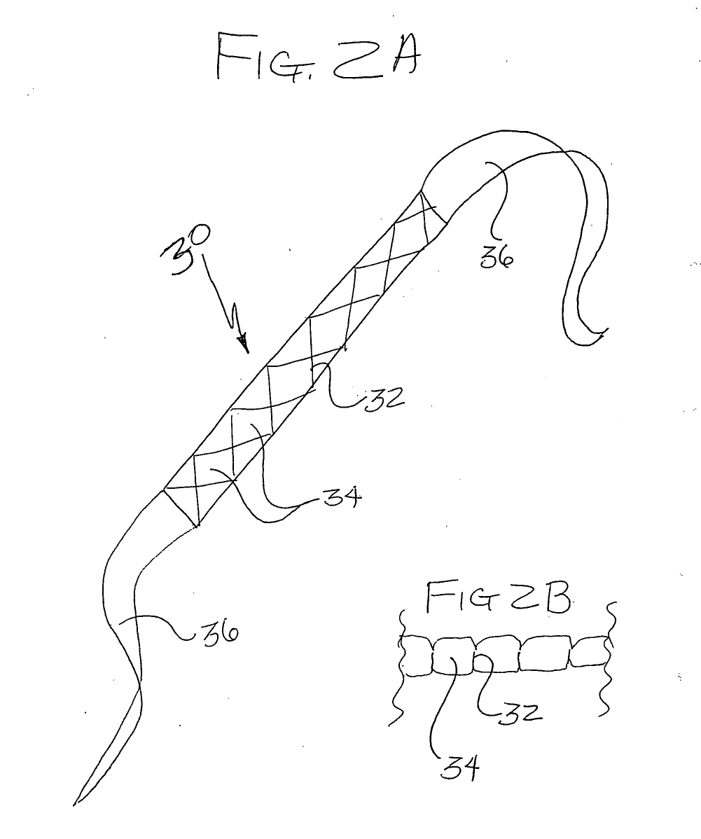

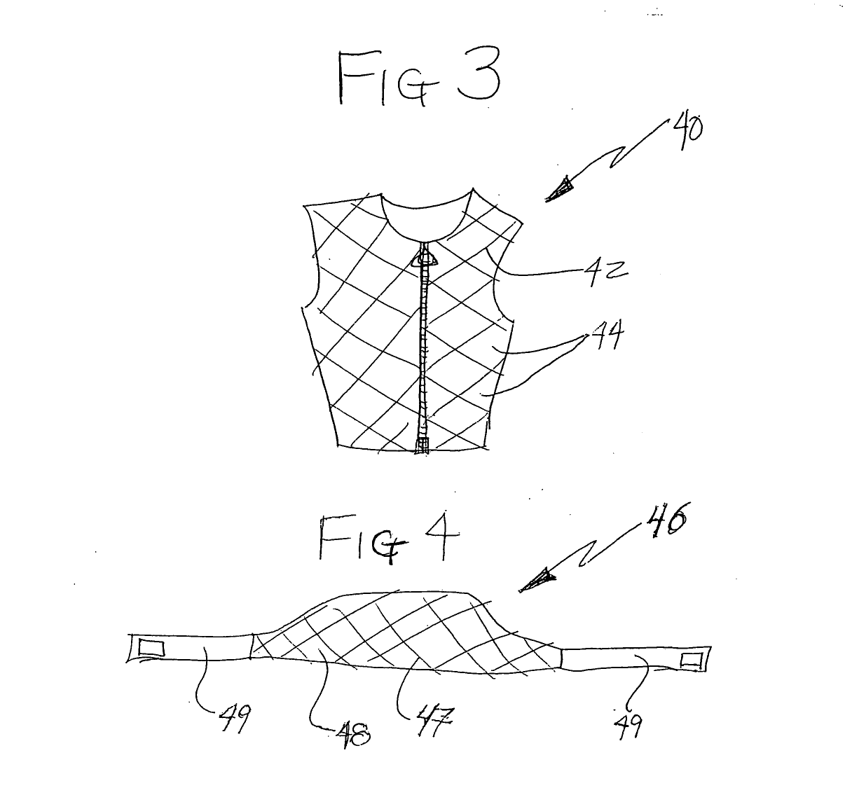

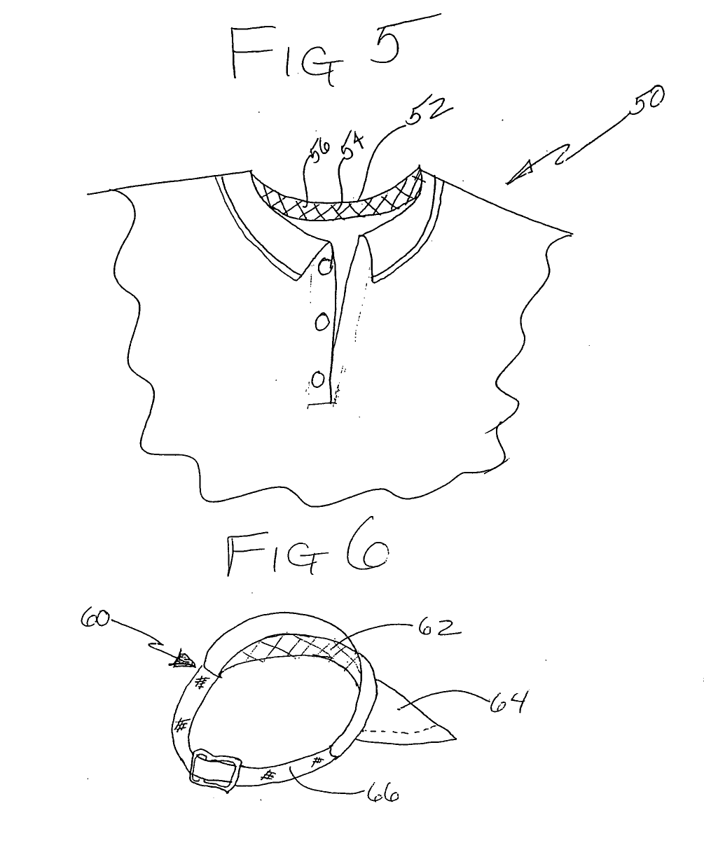

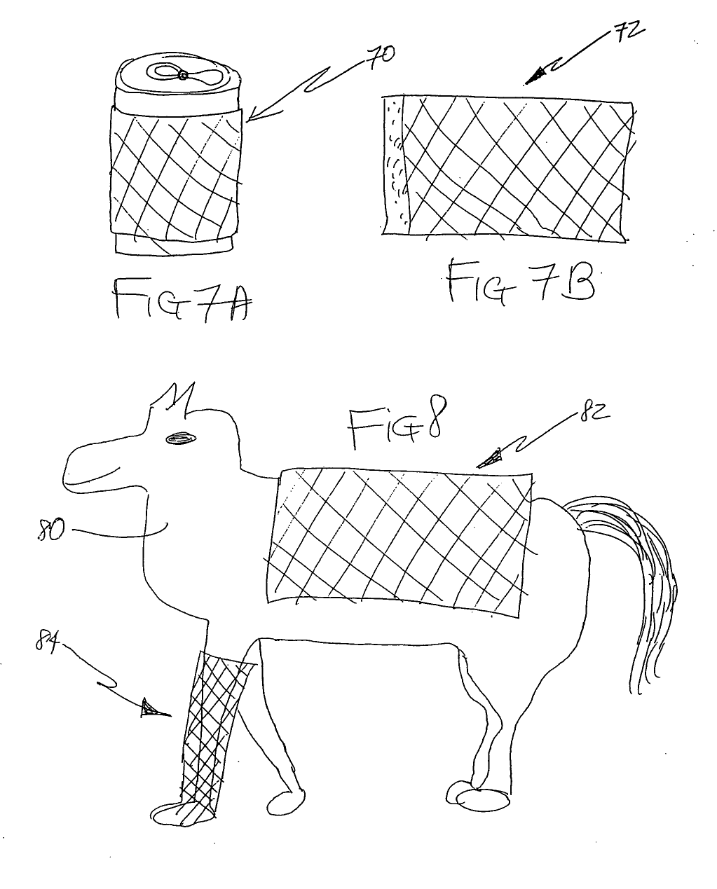

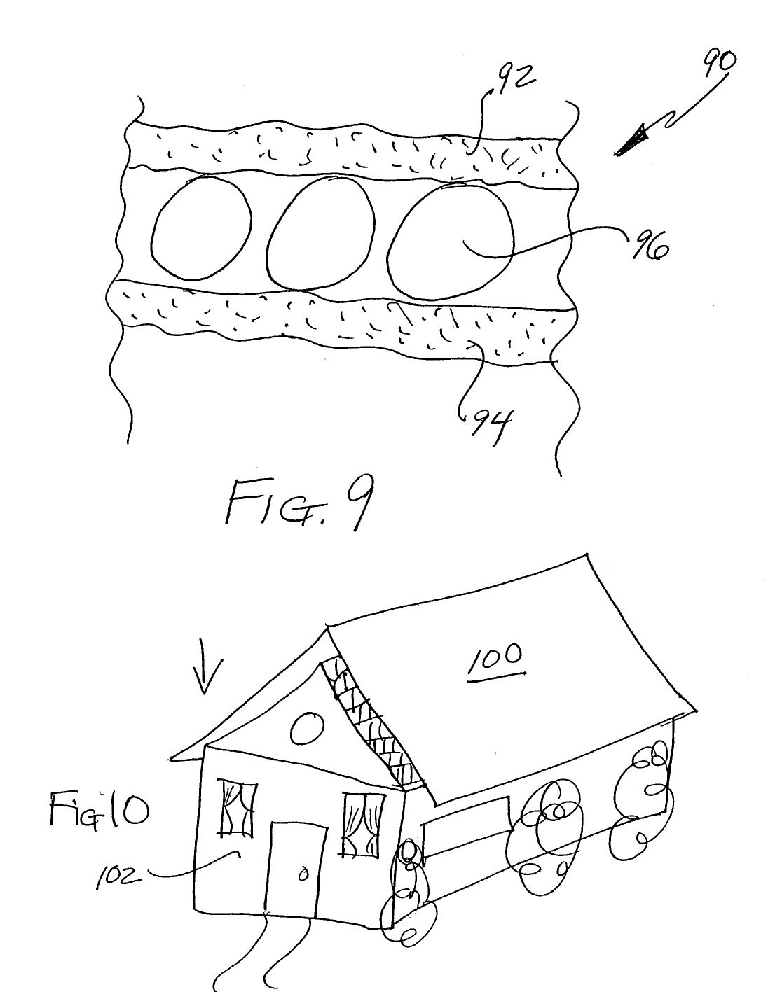

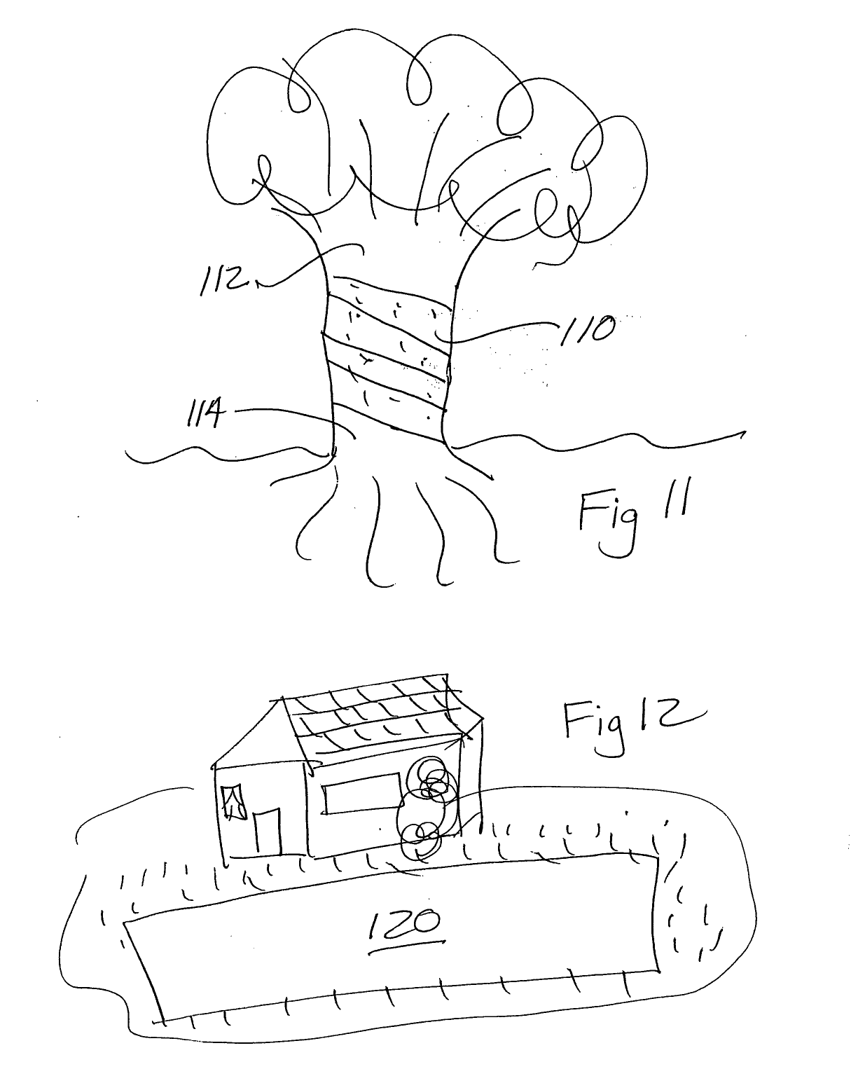

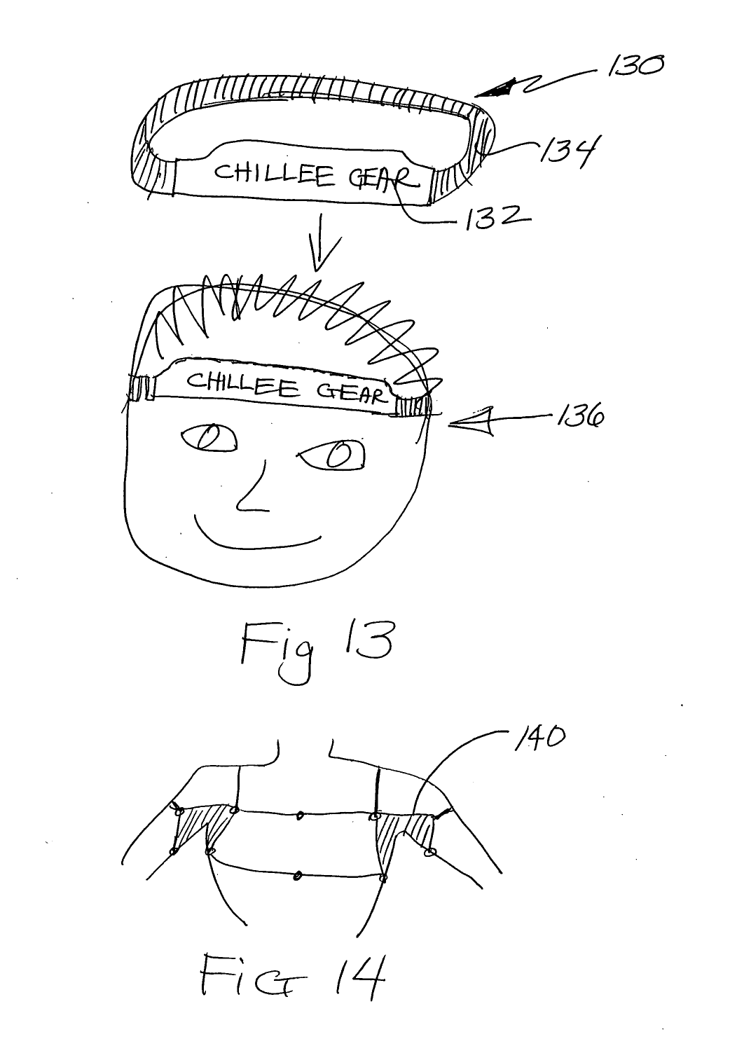

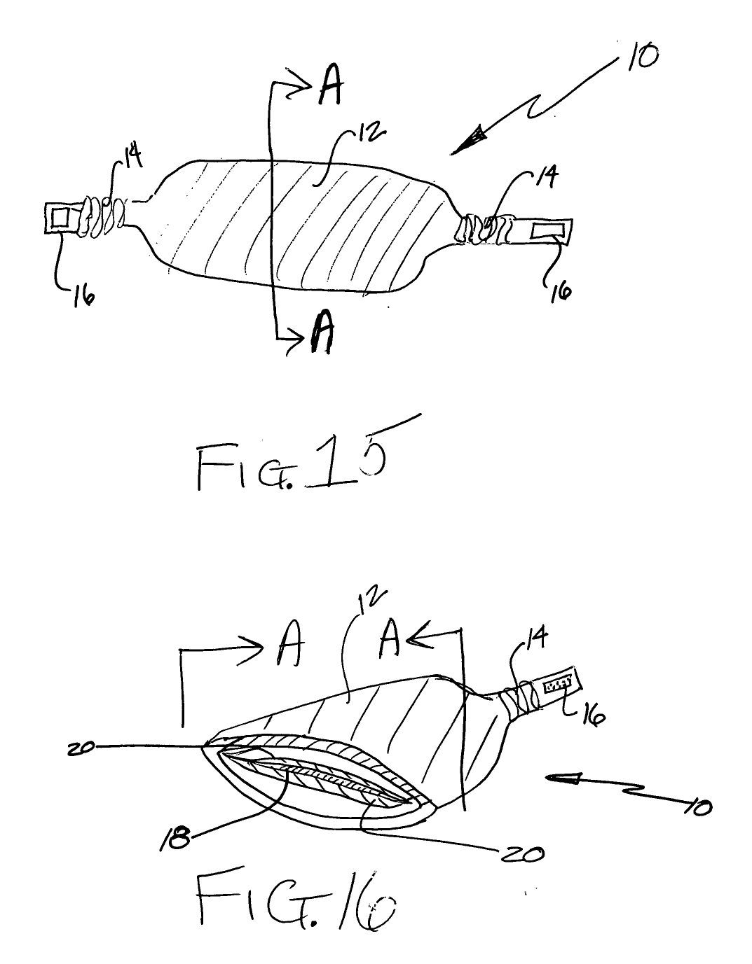

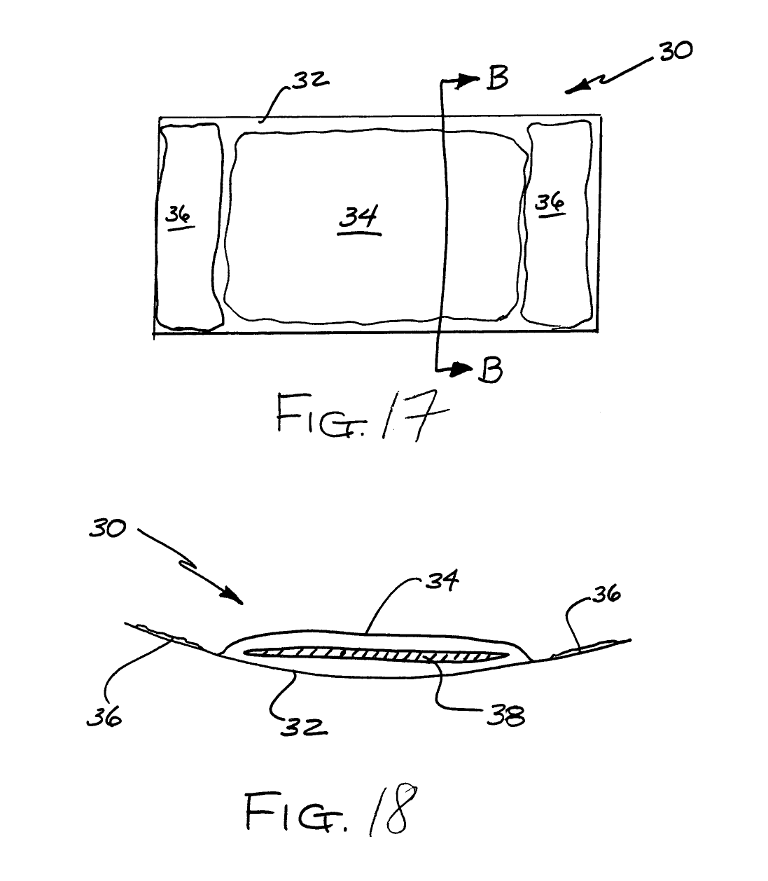

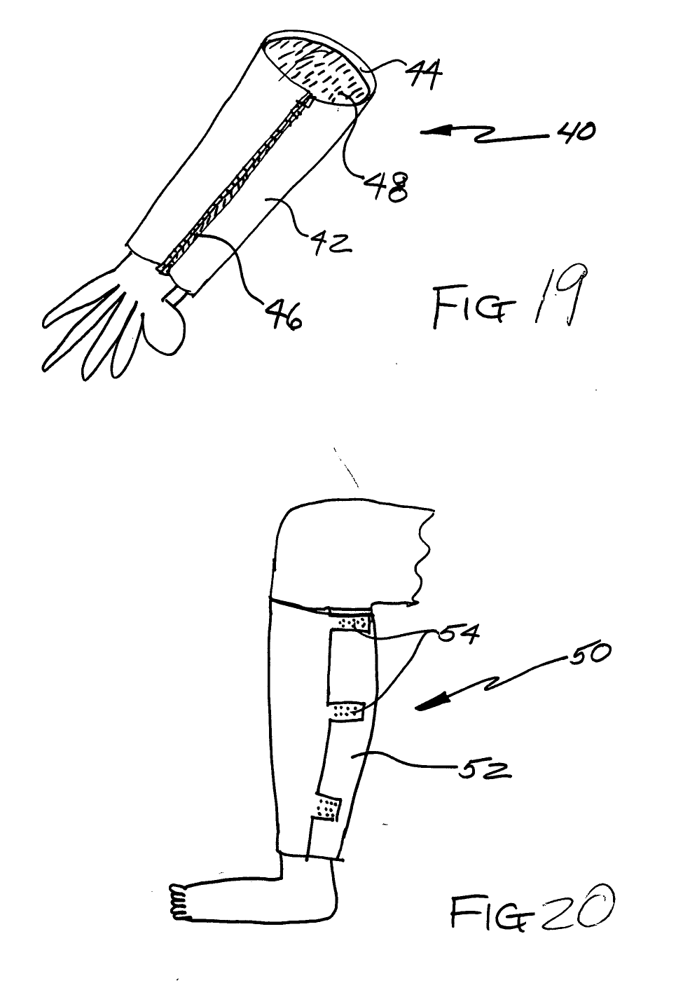

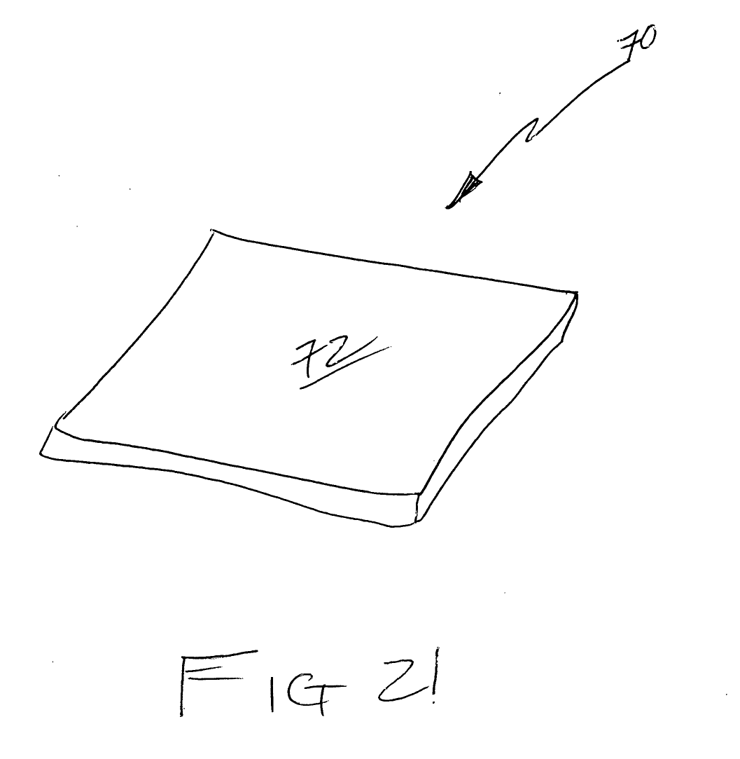

FIG. 2 is a perspective view of one embodiment of the present invention including a neckband with quilted portions having SAP within the quilts;

FIG. 2B is a side elevational view of FIG. 2A, illustrating the placement of stitches to hold SAP in place;

FIG. 3 is a quilted vest having SAP therein in accordance with the present invention;

FIG. 4 is a front elevation view of a kidney cooling belt;

FIG. 5 is a front elevation view of a neck quilted collar in accordance with the present invention;

FIG. 6 is a perspective view of a hat having quilted SAP therein;

FIG. 7A is a front elevational view of a beverage can cooler;

FIG. 7B is a layout design of the beverage can cooler shown in FIG. 7A;

FIG. 8 illustrates cooling devices for horses including a blanket and a hoof cooler;

FIG. 9 shows a side elevational view of multi-layer structure;

FIG. 10 shows a perspective view of a fire deterrent house blanket;

FIG. 11 is a view of a tree wrap made in accordance with the present invention;

FIG. 12 is an illustration of a lawn cover;

FIG. 13 illustrates a sweat absorption device made by the present invention;

FIG. 14 is an underarm and back sweating absorbing article of the present invention;

FIG. 15 is a front elevational view of the hysterectomy pad;

FIG. 16 is a side cutaway view of the hysterectomy pad;

FIG. 17 is a top plan view of an incision pad;

FIG. 18 is a side elevational view of an incision pad;

FIG. 19 is a perspective view of an arm swelling band;

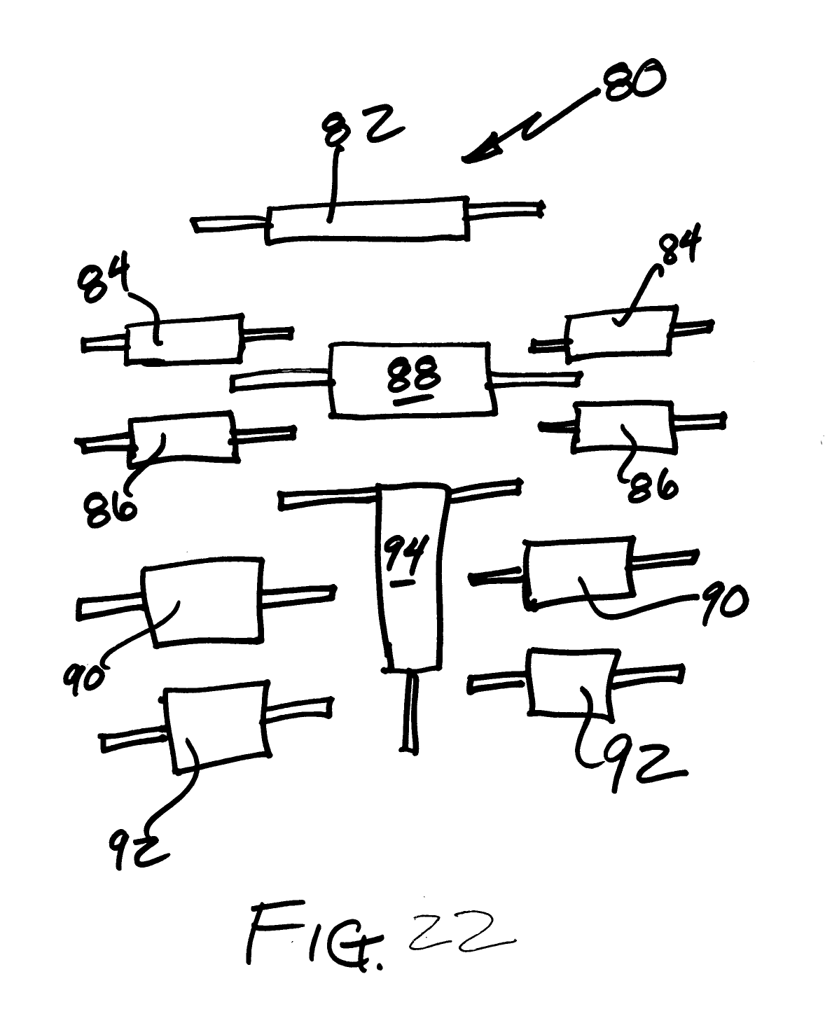

FIG. 20 is a side elevational view of a leg swelling band;

FIG. 21 is a perspective view of a basic pad;

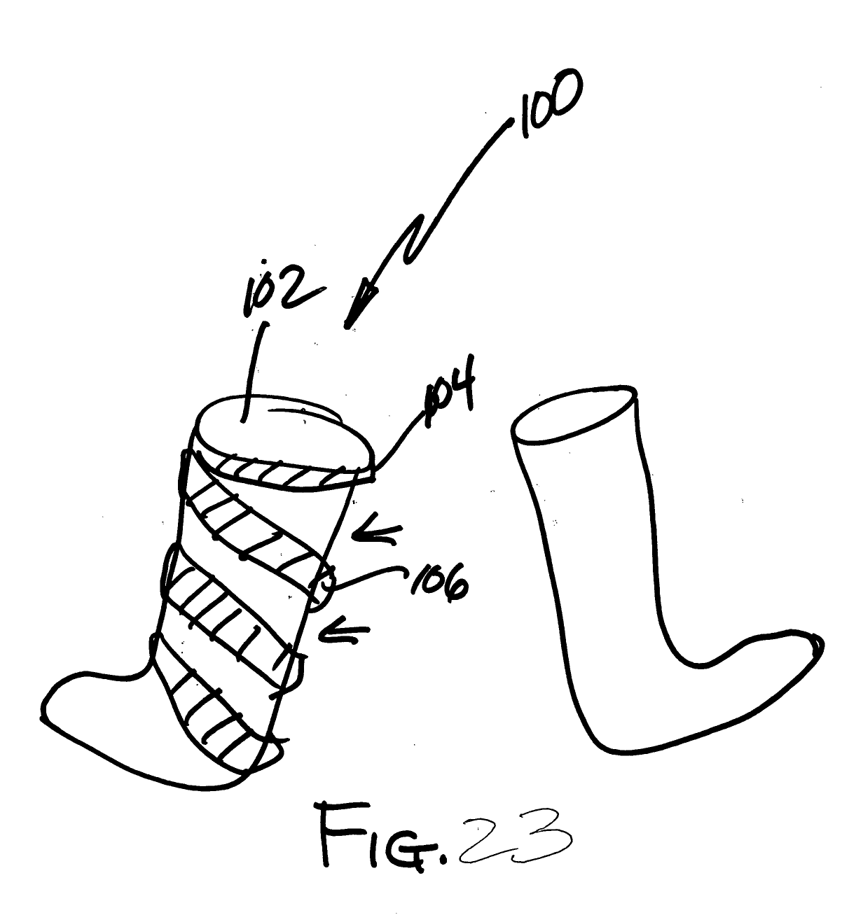

FIG. 22 is a fever reducing suit; and

FIG. 23 is a side elevational view of a foot cooling and compression device.

### DETAILED DESCRIPTION OF THE INVENTION

In accordance with the present invention, there is provided a new configuration for holding super absorbing polymer (SAP) in a manner which provides for much more efficient cooling and wetting than the prior art attempts. In that regard, one embodiment of the present invention is shown by FIG. 1 and the SAP holding mechanism is generally denoted by the numeral 10, including a first fabric layer or inner fabric layer 12, an optional liner material 14, an adhesive layer 16, sandwiching in the SAP particles or crystals 18. As can be seen in FIG. 1, there are voids 20 between the SAP crystals. An optional second adhesive layer 22 is shown, although only one adhesive layer is needed. Furthermore, an optional second liner material layer 24 is shown, as well as the outer fabric layer 26. The inner fabric layer may be worn against the skin of the person who is wearing an article made with the present configuration.

Looking next to FIG. 2A, a neckband made in accordance with the present invention is shown and generally denoted by the numeral 30. Neckband 30 includes quilting stitches 32 and quilted pockets 34. Tie ends 36 are used for securing it around the neck of the wearer. FIG. 2B shows a side elevational view where the quilting stitches 32 are shown forming quilted pockets 34.

FIG. 3 illustrates a cooling vest made in accordance with the present invention, generally denoted by the numeral 40. Cooling vest 40 also includes quilting stitches 42 and quilted pockets 44. Obviously, the quilting pattern can be any pattern which the wearer might desire, and the vest design may have larger armholes or larger neckline or a different hem, and still stay within the scope of the present invention.

FIG. 4 is a top plan view of a cooling kidney belt generally denoted by numeral 46, including quilting stitches 47 and quilting pockets 48. Tie ends 49 may be secured together by velcro, buttons, snaps, or any other suitable means for securing the two ends together.

FIG. 5 shows a front elevational view of a typical golf-type polo shirt with super absorbing polymer inner collar, generally denoted by numeral 50. Included therein is an inner collar 52 having quilted stitching 54 and quilted pockets 56.

FIG. 6 illustrates a visor cap made in accordance with the present invention, generally denoted by the numeral 60. Included therein is a cooling layer 62 against the bill 64 of the cap. The securing band 66 is available in the standard art areas.

Looking next to FIGS. 7A and 7B, a beverage can cooler generally denoted by the numeral 70 is shown wrapped around a beverage can in FIG. 7A, while it is shown as a laid open can cooler 72 with a velcro closing in FIG. 7B.

FIG. 8 shows yet another embodiment of the present invention for the Equine industry. Please note horse 80 having a horse cooling blanket 82 thrown thereon to cool off the horse. Also shown is a horse leg cooling device generally denoted by the numeral 84 for cooling down the leg and hoof of a racehorse after it has been running.

FIG. 9 shows the most simple configuration of the multi-layer structure in accordance with the present invention. The multi-layer structure 90 includes at least an inner and an outer layer, 92 and 94, respectively. Contained therebetween are super absorbing polymer particles 96. Particles 96 may be incorporated into the inner and outer layers 92 and 94 in certain manufacturing applications. An example of such an integrated structure is available from Gelok Corporation of Ohio, in which the polymer is intermingled with other paper pulp and/or other fibers, which is then formed in a felted material, which is then de-watered to produce a dry fabric multi-layer structure. As discussed above, with reference to FIG. 1, additional layers may be useful for specific applications. For instance, the cooling application is intended to absorb sweat by the wearer, and then act as a coolant as the water evaporates, thereby cooling the device, and subjecting the wearer to a cooler temperature than atmospheric. In the cooling application, it would be preferred to use a liquid pervious material or fabric such that the water in the sweat of the wearer can be absorbed by the super absorbent polymer, without allowing the wetness to ooze back through the membrane to contact the neck or body of the wearer.

The present invention is useful in many applications, although three categories find especial utility, those being performance, comfort and cooling garment applications, medical garment applications, and fire blankets for houses, trees and the like. The performance, comfort and cooling garment applications include, but are not limited to, headbands, skull caps, bandanas, T-shirts, shorts, bodysuits, menopause pajamas, bed wear for sweat absorption, vests, motorcycle garments and head coverings for under motorcycle helmets, sports gear for wearing under sports uniforms (for cooling and absorbing sweat), cooling pads for dogs to lay down on, cooling blankets for cooling off horses and other animals and various other comfort clothing.

Medical applications include, but are not limited to, a hysterectomy or other incision-covering band to alleviate itching and burning during healing; arm and leg wrap garments in combination with compression stockings and arm bands from 8 mm Hg to about 50 mm Hg compression to reduce swelling, fever reducing suits for cooling an entire body, eye masks for sinus relief, whole head headache relief skull cap-type head coverings that can be hydrated and then either refrigerated or frozen depending upon the preference of the wearer; a heart by-pass (or any other lengthy incision) cover-up to prevent itching and burning during the healing process; anti-microbial cooling combination gear that may be made into any of the items listed hereinabove; bed pads for bedsore prevention; and any other suitable configuration for sweat absorption or cooling.

As the preferred concentration of the SAP is generally greater and better distributed than other products on the market, the present invention tends to last longer than prior art devices. For example, to the best of Applicants' knowledge, all of the products from the Hydroweave® division of 3M International of Minneapolis, Minn., include “fluff” or batting to hold the SAP particles in place. This feature renders the garment much thicker, and the fluff does not absorb as much water as the SAP. Therefore, the garment overall does not absorb as much water as the present invention where the concentration of SAP is much higher. The Hydroweave® material is much thicker, so it is not as attractive for everyday use. Firefighters that use the Hydroweave® material in their bunker pants, etc., do not care what their fashions look like, rather they seek the functionality and heat resistance provided by the fluff or batting. Further included is a waterproof barrier layer, while the present invention seeks to transport the fluid to the outside of the garment for evaporation, which results in the cooling feature.

Again, another embodiment of the present invention may include any number of additional features including a sulfonation treatment for enhancing wicking and providing anti-microbial properties; the inclusion of other anti-microbial properties by adding zeolite, silver threads or coatings of the yarns used for the fabric layers, the use of odor control substances including enzymes/microbes, baking soda, calcium carbonate, fragrances, detergents, or other effective odor control substances, dirt and oil eating enzymes and/or microbes for keeping the garments cleaner, especially in the neck and underarm regions.

For the usage of the cooling garments, the garment is soaked briefly in water in order to wet most of the SAP. The non-woven or fabric outer layer feels mostly dry against the skin of the wearer after this operation and any sweat generated by the wearer is absorbed further by the SAP, as the brief soaking does not nearly saturate the SAP. These fluids are wicked to the outer surface as some of the water evaporates into the atmosphere. This transport of the fluid aids in the cooling process, and keeps the wet feeling away from the garment wearer, making the garment more comfortable while wearing and aids in the cooling experience.

As the absorbent core of FIG. 9 is incorporated into the final sewn garment, rather than fluff-SAP combinations or loose crystals held in tubes of the fabric, the distribution of SAP is more even and provides a more even distribution of cooling and absorption, as well. For cooling applications, the most preferred embodiment utilizes an air-laid tissue laminate structure with SAP at a concentration of about 25 grams/sq. meter available from Gelok Corporation of Dundee, Ohio. This tissue laminate is cut to shape and sandwiched between two layers of cut-to-size DuPont Sontara® non-woven fabric, which is then sandwiched between two layers of any configuration of desirable fashionable fabric. The Gelok SAP tissue is cut to a shape which will fit within the seam allowances of the desired garment, and the tissue is sewn within those borders after it is “encapsulated” within the Sontara® non-woven. This particular configuration and structure provides a cooling garment which does not ooze SAP through the outer fabric, but still exhibits the desired cooling properties. This configuration is especially useful for headbands, skullcaps, bandanas and other performance/cooling applications, as well as for the various medical applications of the incision covering pads.

For the fire blanket configuration, the same air-laid tissue laminate SAP structure is useful in combination with a durable non-woven material for strength. Several layers of the tissue laminate may be most advantageous to provide more water-holding power. The various layers may all be sulfonated to provide near instantaneous wicking of water into the core for maximum hydrogel formation. The outer fabric layers may further include a fire retardant or fire-proof coating of methacrylate-containing solution or any other widely known and used fire retardant coating/treatment.

The fire blanket may be of many configurations, but the overriding consideration is that the hydrogel-forming core must be capable of holding a great deal of water to protect the house or building from the fire. As this can get very heavy over the square area needed for a residence or building, it is likely that additional weight support may be necessary, such as nylon webbing straps to run vertically down the fire blanket, and the straps should be distributed spatially at a rate of from about every six inches to every couple of feet. The present inventors also envision a water distribution system included in the construction which will automatically evenly distribute water throughout the entire house blanket. Such a distribution system may include a seeping hose system permanently attached inside the blanket in the configuration of an electronic busbar system for providing a short travel distance between distributor hoses for even distribution of water to the SAP particles held in place.

Furthermore, the fire blanket may be permanently attached to the roof of the house, in a rolled up configuration that can be unfurled at a moments notice. If this blanket included the water distribution system, then a simple flipping of a switch could release the blanket down over the house, followed by starting a water pump pumping water through the imbedded water distribution system. The homeowner could flip the switch, and immediately evacuate the area, while the house protection blanket would go to work saving the homeowner's house.

Alternatively, the house blanket material could be sold in relatively wide strips at a large box home improvement store, cut to size on rolls. The strips may be from one foot to about eight feet wide, and they may be sealed on the edges with a nylon web strapping. Large pockets could be formed by sewing, heat sealing, adhesives, etc., yielding a strip that could keep the SAP evenly distributed during a fire. The outer fabric layers may be treated with a fire retardant that is still water permeable, or liquid pervious, so that the hose water could get through the outer layer and soak into the SAP core.

Some people may not desire a permanent installation. An enterprising homeowner may learn of an impending fire heading toward his home, go to the home improvement store, buy enough of the strips to cover his house, and go home to install it. The homeowner could climb onto his roof and begin to cover his roof and house sides with the unrolled blanket material, starting midway with the strip at the peak of the roof, allowing the lengths to unfurl down the roof and come to a resting position covering both his roof and the sides of his house. The strips should overlap enough so that none of the house would be exposed. Then, he could spray the blanket material with his garden hose until the SAP absorbed enough water to effect fire prevention. If all the outwardly facing layers were sulfonated, the water would nearly instantaneously wick into the SAP core where it could be absorbed into the core.

After the fire, the blanket or strips could be allowed to dry in place. This can take from one to seven, hoping that there will not be any rain. After the strips are dried, they may be re-rolled for another use. The same principals apply to the tree wraps and the lawn covering.

### EXAMPLE

A 1 3/4 foot by 1 3/4 foot, nearly four square foot, 356 micron thick, air-laid tissue SAP laminate was sewn between two 2′×2′ layers of DuPont Sontara® non-woven fabric, with a seam allowance of about ¼ inch all the way around the laminate. This construction was then sewn inside two layers of basic cotton material, quilting weight. The laminate weighed 5.1 g/sq. ft, with an evenly distributed weight of SAP of 20 g/sq. m. The absorbency of such a configuration submerged in a tub of 0.9% NaCl aqueous solution was 1080 g/sq. m. within 30 seconds, and 1610 g/sq.m. within five minutes. The tensile strength was 1.0 kg/in, with an elongation factor of 13.5%, yielding an absorbency of 18.2 sq. m./kg. The results of this test were excellent for both cooling and absorbency applications. This test piece performed cooling functions for nearly three days before drying out too much to perform.

In order to accomplish the advantages sought by the present invention, the absorbent core inner structure of the present invention is made of super absorbent particles that have been secured between an inner and an outer layer of fabric, whether woven or non-woven. Each of the inner and outer layers are liquid pervious materials, and allow absorption of fluids, most notably water, but also other bodily fluids and substantially aqueous solutions, while providing a mechanism for the transport of such fluid to the outside of the super absorbent core. In direct contradistinction to the prior art, there is no fluff or cellulosic fibers utilized loose in order to secure the SAP particles. In the present invention, the SAP particles are secured either through heat, pressure, bonding, adhesives, electrosonic welding, acoustic welding, light crosslinking, laser beam seaming, or any other known method for forming a laminate structure for securing the super absorbent particles.

This absorbent core material is then secured between an upper and a lower sheeted material in order to provide a super absorbent structure which allows for the absorbance of fluids, the transport of those fluids to the other side of the structure, and eventual evaporation on the outer most layer of the absorbent structure.

The preferred super absorbent polymers include acrylate granules, cross-linked polyacrylate polymer, polysodiumacrylamide, starch-grafted polyacrylate polymer absorbents, hydrogel-forming absorbent polymers, olefinically unsaturated acids and anhydrides containing at least one carbon-to-carbon olefinic double bond, ethylene oxide polymers, cellulose derivatives, and other synthetic polymers including polyvinyl alcohol, among others. Such polymers are generally capable of absorbing water in amounts of at least 100 times the weight of the polymer. Preferably, for the designated purpose of the present invention, it is preferable that the super absorbing polymers absorb liquid at a rate from about 400 to about 20,000 times the weight of the polymer.

The concentration of the super absorbing polymer is present from about 5% percent to about 50% by weight of the laminate layers, commonly polyethylene or polypropylene. The SAP particles are dispersed between the layers at a density of from about 10 to about 500 grams per square meter, and preferably from about 20 to 250 grams per square meter. A particularly efficacious absorbent core structure includes a polyacrylate crosslink scattered on an absorbent tissue with about 25 grams per square meter of SAP that is heat pressed to prepare an absorbent material core.

This material core is then cut to be encapsulated within outer layers of fabric that are liquid pervious to allow for absorption of fluids and transportation of the fluids therethrough. The fluids may evaporate on the outer side, thereby providing cooling to the wearer, or to provide wetness in the case of the fire blanket described in greater detail hereinbelow, such that flaming embers which would come in contact with the fire blanket after it has been activated will experience a quenching by the water exposed to the surface.

The present invention is unlike the absorbent articles used to manufacture disposable diapers and sanitary napkins because the SAP particles are suspended by fluff in those applications. The present invention desires a slimmer profile, one that transports liquids from one side to the other in order to make it more efficacious as a cooling performance material or as a fire deterrent article. In addition, the present invention is unlike the prior art which describes loose crystals held in fabric tubes, as the SAP is held in place within the absorbent core material prior to being sewn and held in place through the seaming activity. As an alternative to sewing, the present invention is quite amenable to heat pressing, water pressing, pressure of other sorts including acoustics, adhesives and binders, and any other means of mechanically, chemically, or pressurizing methods known in the art.

In addition to the various sealing methods, another preferred embodiment of the present invention includes the use of order control and dirt control incorporated into the SAP granule layer laminate. Such odor control may be affected by the addition of baking soda, calcium carbonate, zeolite structures, fragrances, and/or detergents to be co-mingled with the SAP powder granules before laminating between the two sheets of material.

In addition, microbes and/or enzymes in a dry form may also be added such that, when activated with water, they will remove odors by breaking the aromatic bonds in smelly ring compounds, as well as eating oils and dirts in order to keep the garment that is utilizing the cooling absorbent core clean. Such enzymes and microbes are available from many different sources, although vegetable protein enzymes are preferable, as they are non-toxic and remove odors more effectively. Such enzymes may be made from apple skin, blueberry skin, or vegetables and starches. By securing the enzymes and/or microbes with the crosslinked super absorbing particles, the enzymes can remain in the garment during multiple washings in order to be effective for longer periods of time. The odor control agents, i.e. calcium carbonate, zeolite, etc., can be time-released fragrances and zeolite, etc., by placing numerous layers of cellulose and/or starch around powder particulates of the various odor control mechanisms. Such time-released capsules are well known in the art, and would allow the wearer to experience the performance of the odor control for anywhere from about one washing to about fifty to one hundred washings.

Further, experiments have been performed which include exposure of the various sheeted material layers of the present invention to a sulfonation gas, i.e. sulfur trioxide gas. This provides a nearly instantaneous wicking through the fabric of water that is generated by the wearer or, in the case of the fire protection blanket, instantly upon application of water to the absorbent material. Sulfonation is effected by exposing the fabric to the sulfonation gas for a sufficient length of time, on the order of from one second to sixty seconds, in order to form sulfur crosslinking on the surface and through the bulk of the material. The sulfur-containing gas provides a very desirable characteristic, i.e. that being instantaneous wicking. In other words, rather than having to wait for seconds or minutes for the water to penetrate into the super absorbing particles, if they have been previously subjected to a sulfur-containing gas, and preferably neutralize thereafter, then the water is wetted into the SAP almost instantaneously. This is very advantageous in the application of the house protection blanket, as time may be of the essence when fighting a fire in order to have the SAP absorb the water as quickly as possible.

In the sulfonation process, a large piece of fabric would be put into a container which is air tight, and sulfur trioxide gas would be forced into the container, allowed to remain resident for an effective amount of time, as described hereinabove, and then evacuated to the best ability of the operator. Preferably, thereafter, the fabric which is now in an acidic state due to the exposure to the sulfur-containing gas, may now be neutralized with ammonia or any other neutralizing agent, including metalization, to render the fabric as anti-microbial, odor controlling, and extremely wicking. Concentration of the sulfur in the polymeric sheeted material of the present invention are on the order of micrograms, and are effective in extremely small amounts, such as 0.001 micrograms to 100 micrograms per square meter. Such a sulfur containing gas may slightly alter the appearance of the fabric, but that is only a concern for the performance clothing applications described herein. For the house blanket, any yellowing or discoloration is acceptable. The sulfonation procedure may be done at room temperature and ambient pressure, although it is advisable for the operator of the machine not to breathe too much of the fumes. The sulfonation process is advantageous for both the laminate layers of the absorbent core material, as well as the inner and outer layers utilized for the fabric.

Tests were performed on untreated outer fabrics, where water took between one and five seconds to transport through the fabric to the other side. However, a sulfonation-treated fabric wicked the water therethrough instantaneously.

Preferred non-woven fabrics to be utilized in the absorbent core structure may include a spunlaced material which is a non-woven textile sheet fabric. As spunlaced material fabrics do not use any binders, surface modifiers or adhesives to hold the fibers together, the possibility of product contamination or user allergic reactions is minimized. Such a fabric is available from the Dupont Corporation Sontara® Technologies, Inc., of Wilmington, Del. The technology of Sontara® turns Dacron®, available from Dupont Corporation of Wilmington, Del., polyester fibers into fabric by hydroentangling. Hydroentangling means the shooting of thousands of high-pressure (up to 2,000 psi) needle-like jets of water at a random batting of blended fibers. The jets entangle the fibers into a fabric, which is then dried and wound onto a fabric roll. These fibers may be entangled to form a non-woven fabric with or without repeating patterns or no patterns at all. As any combination of fibers can be entangled, including polyester, rayon, acrylic, nylon, wood pulp and cotton, performance characteristics may be specialized for individual applications.

In the fire blanket application, strength of the non-woven fabric is an issue, as the super-absorbent polymer gets very heavy when wet in such large sheets. It is envisioned by the present inventors that additional high strength webbing will be utilized up and in a vertical relationship across the face of the roof in order to support the weight. In other words, nylon webbing straps shall occur every foot to two feet apart in order to provide support for the weight of the fire blanket when wet. Such webbing may include a water distribution system so that a water hose can be connected at one end of the top or bottom of the fire blanket and the hose may be turned on providing a distribution of water across the majority of the surface of the fire blanket itself. If the fire blanket has been sulfonated, then the water will be absorbed more quickly.

The sheet core material as shown in FIG. 9 may have many embodiments, including a super-absorbent polymer base between two cellulose sheets, air-laid tissue for natural biodegradation, or polyester non-wovens for durability. For all the applications described herein which would touch a human or animal body, it may be preferable to utilize the air-laid tissue, as it is most benign to the wearer. Polyester non-wovens are durable and are also non-toxic and non-allergenic. Further, the laminate materials may include cellulose tissue, air-laid tissue, polyethylene backing, papers, web or netting, non-wovens, and specialty items which may include iron filings for magnetic attraction, metal absorbents, flocculants, activated charcoal carbon, catalytic and activating materials, organometalic clays, dessicants, and the like. Combinations of all of those may also find great advantage.

For sweat absorption applications, it is preferred to utilize an inner layer of liquid pervious material for allowing the sweat of the wearer to be absorbed by the super absorbent polymer. Of course, the application of this sweat absorbing multi-layer structure would preferably be placed closest to the points on the body where sweat is generated.

For fire deterrent applications, described more fully hereinbelow, the amount of super absorbing polymer should be maximized such that, when contacted with water, the multi-layer structure should swell up to a thickness of between about one-half inch and up to about six inches.

As one can imagine, there are many more embodiments which could utilize this technology for cooling items, people, and even animals. The applications are too numerous to list in this patent application. However, they must all have one thing in common, that the SAP particles are held in place. This is in direct contradistinction to the prior art in which the SAP particles are poured into a tube. Some of the most preferred embodiments of the present invention are within beach towels (having a waterproof plastic lining to be placed facedown on the sand with the SAP side towards the sunbather), socks, mattress pads, absorbing pads under pet dishes, leaky sinks, fever reducing blankets, workout gear with built in SAP multi-layer portions in blood cooling areas of the garments, dry pads for sweat absorption in undergarments male and female, and fire deterrent articles that act as a “blanket” of water to prevent fire from burning down a house or other building, tree or lawn.

FIG. 10 illustrates a house blanket 100 constructed in accordance with the present invention, to cover an entire house. House blanket 100 should be a dry blanket as described in the present invention which can be dropped over an entire house in the event of the knowledge of a fire coming towards the house. The dry blanket could be lifted up to the roof, rolled down the pitch of the roof, and watered down with a hose. Alternatively, the blanket could be permanently mounted on the roof. This rooftop application may include a water distribution system formed into the blanket. The high absorbency super absorbing polymer crystals most advantageously will be employed in amounts of from about ¼ teaspoon per square foot to about 10 teaspoons per square foot. The high absorbency material should be a hydrophilic compositions of about 400 to about 10,000 times its weight of water, and, when wetted down, will swell up with water, preferably to a thickness of between one-half inch and six inches thick. When the fire comes close to the house, flying embers from nearby trees will float through the air and land on the wetted down blanket. Instead of starting a fire on the roof of the house, the wet blanket will extinguish the flying embers, and the house will be saved. As one can imagine, the blanket can be one large piece the size of a normal ranch house, or a multiple set of small pieces, or long strips, having a dimension of from about one to two feet wide by about thirty to about fifty feet long, such that the homeowner would be able to easily lift the strips to the peak of the roof, and let the rolls unfold down the roof, making the edges touch or overlap by standing on the roof, and having a companion straighten out the bottom of the strip.

It has been noticed that wet baby diapers do not burn in house fires, and fire fighting equipment was made with SAP based on that principle. However, the present invention discloses and claims a protective blanket for an entire home, the surrounding lawn, and tree trucks. The house blanket preferably has the SAP loosely adhered to the lower material substrate, so that the SAP will not shift during installation on the roof. The upper layer should be a loosely woven material that will allow water to easily flow therethrough, so that the homeowner can wet it down with his garden hose when he is standing on the roof, or a ladder, and prevent the forest fire from attacking his home.

FIG. 11 illustrates the tree trunk wrap concept, shown generally by numeral 110 being wrapped around tree trunk 112, above roots 114. This embodiment again benefits mostly by using a high concentration of SAP crystals, on the order of one to about 10 teaspoons of SAP crystals per square foot, so that it will absorb a great deal of water, and prevent flying embers from a nearby forest fire from burning down the entire tree. In the alternative, it is also envisioned that a large lightweight SAP blanket, made in accordance herewith, could be thrown over the entire tree, wetted down, and prevent the burning of the tree.

FIG. 12 shows a lawn blanket generally denoted by the numeral 120, which again is the preferred structure, materials and concentrations for the house blanket 100 and the tree wrap 110, described hereinabove. The lawn blanket may be used to protect the lawn in the event that a homeowner knows that a forest fire is coming toward his house.

The huge advantage that these blankets and wraps as shown in FIGS. 10-12 display is that a homeowner generally has a couple of days notice when a forest fire is heading in their direction. The blankets and wraps are very lightweight when dry, and they could easily be put into place by the homeowner. He could secure them into place, if need be, and then begin spraying them down with water. The preferred SAP crystals, as described above, are finely ground, from a mesh size of about 10,000 up to about 50 mesh size, and easily and quickly absorb water. The blanket, once it has absorbed all the water it can, will swell up to a good thickness, and it will stay wet for several days, even though the forest fire could be raging all around it. Flying embers from burning trees will fly in the air, and land on the wet blanket, whereby they will be immediately extinguished. The fire would have to rage for days right next to the house, tree or lawn to dry out the SAP enough so that it wouldn't work. By having one of these blankets at his home, a homeowner could reduce his insurance premiums out west where forest fires are prevalent.

Tests show that this structure will not burn in a fire, but rather any flaming embers contacting the structure are immediately extinguished. This effect is expected to continue until the SAP evaporates all the water it is holding.

Looking next to FIG. 13, there is shown a sweat absorption embodiment of the present invention, generally shown as 130, having the swear absorption portion 132 in a location which can be placed over the forehead 136 of a wearer. Elastic band 134 can go around the head of the wearer, and the entire configuration may be worn as is, or it may be worn under a helmet, etc. Sweat would be absorbed rather than drip down into the eyes of the wearer. The configuration of the multi-layer structure would preferably be the same as the neckband configuration described hereinabove with reference to FIG. 1.

Referring now to FIG. 14, there is shown a sweat absorption garment protector 140, which would be made in the same configuration of multi-layer structure as the sweatband and the neckband above. However, it would be preferable to have a waterproof outer layer to be worn away from the body, such that the wetness would not moisten or stain the clothing being worn thereover.

Generally speaking, the preferred embodiment for each of the above applications includes an upper and a lower layer of material with a high concentration of high hydrophilic super absorbing polymer crystals therebetween, like 400 times to 10,000 times absorption rate. The upper and lower layers of materials may be made of any material which will allow water to easily flow through.

Furthermore, it is preferable to have much smaller crystals than the prior art, such as Aridall 1460 or Aridall 2000, available from Chemdal Corporation of Palantine, Ill., as the soaking time is reduced greatly. The particle size ranges from approximately 15 micrometers to 0.25 centimeters, and have hydrophilic factors of from about 20 to about 10,000, depending on which SAP and which particle size is utilized.

The inner and outer fabric layers may be made of any fabric, although they may both be lined with the optional liner material. The liner material is preferably available from Kimberly Clarke Corporation of Atlanta, Ga., and is a liquid pervious material sheet which allows water to pass through but not back out. However, any suitable liner material may be utilized. Although it is most preferable to have the optional liner material closest to the body of the wearer, it is possible that the liner material could be used on both sides of the SAP particles. A low density fiber mat can act to prevent any oozing of the SAP material with the water being transported through the fabric onto the skin of the wearer alleviating the aforementioned “rash” problem associated with the prior art. As this is undesirable, the liquid pervious material sheets can be utilized to prevent this from happening. Of course, for the fire deterrent and other wetting applications, do not require any type of membrane.

Further, for many of the above applications, the present invention also includes recitation of the use of powdered time-released fragrance powders and powdered enzymes to be included along with the powdered SAP crystals. The fragrance powders are preferably spray dried cyclodextrin coated fragrances, or cellulose spray dried coated fragrances, such that they may be used for aromatherapy applications for the clothing applications. Imagine putting on your sweat absorbing headband and your personal cooling neckband, and smelling menthol coming across your face. Menthol fragrance has been proven to provide a stimulating effect, such as waking someone up. If you wanted to relax, you would wear your lavender scented neckband or wristband so that you would smell lavender.

The inclusion of commercially available enzymes, especially in a time release format of cyclodextrin or cellulose spray dried coated enzyme powders, would be helpful as they deodorize and kill any bacteria which may arise and cause odor problems. For instance, in the sweat absorbing undergarment of FIG. 14, enzymes incorporated into the multi-layer structure as particles 96 of FIG. 9 could be used to keep underarm odor in check. Those enzymes are safe for human contact, and would never actually touch the skin due to the use of the liquid pervious material sheets.

Looking next to FIG. 15, there is shown a particular embodiment of the present invention including a hysterectomy or cesarean incision cover generally denoted by the numeral 10 including a super-absorbing pad cover 12 with an optional plastic cover which is not shown in FIG. 15, but may be utilized. Such a plastic cover would preferably include a slightly perforated plastic cover in order to allow the moisture from the super-absorbing pad contained therein to release some of its contents. Securing tabs 14 are shown at the proximal and distal ends of the incision cover 10 and may incorporate an elastic band for utilization around the waist of a patient. Fasteners 16 are shown at the ends of securing tabs 14, and may be made of any suitable fastener, including Velcro® (a registered trademark of 3M Corporation of Milwaukee, Minnesota) hooks and eyes, loops, lacings, or any other conventional suitable fastener. The incision cover generally denoted by the numeral 10 may include the utilization of a super-absorbing polymer underneath the super-absorbing pad cover 12 as more fully described hereinbelow with the ensuing figures. For example, FIG. 16 is an illustration taken along lines A-A of FIG. 15, illustrating the interior of the incision cover 10 shown in FIG. 15.

Looking next to FIG. 16, there is shown a cross section of the incision cover 10 taken along lines A-A, illustrating the inner core of super-absorbing polymer 18, and surrounded by a membrane material 20 which may be any fabric, but is preferably liquid pervious material sheets allowing water to be released from the super-absorbing core. Such a fabric or membrane may be a woven material, oriented strand material, a felted type material that is porous, a wettable non-woven oriented strand material, or any other suitable material which will allow the release of the moisture held by the super-absorbing polymer incorporated into the core 18 as shown in FIG. 16. It may be any suitable super-absorbing polymer, including those that will absorb from about 50 times their weight in water to those that will absorb more than 10,000 times their weight in water. The super-absorbing polymer may be loose granules, such as those available from many corporations, including Dow Chemical of Midland, Mich., Chemdal Corporation of New Jersey, or any other conventional source for those materials. In the alternative, the super-absorbing polymer may be incorporated into a felted matrix, such as that material which is available from Gelok Corporation of Toledo, Ohio, and most preferably utilizes the matrix of liquid pervious material sheets with a super-absorbing polymer incorporated into a paper felt such as that available from Chillee Gear Corporation of Fort Wayne, Ind.

In addition, the super-absorbing core 18 may also incorporate various other chemicals to achieve different effects. Such effects may include anti-microbial action, aromatherapy, enzymatic effects, mosquito control, and medicinal applications to name a few. Anti-microbial elements may include elemental silver, zeolite, zinc or copper, or any other commercially available anti-microbial material for helping in the healing of the incision. Furthermore, the super-absorbing core 18 may also incorporate other chemical products including essential oils, such as peppermint, eucalyptus, lavender and other essential oils for aroma therapy effects, as well as enzymes including microbes, enzymes and other bacteria-eating compounds which may be incorporated in order to help heal the incision. Garlic oil may be used for mosquito control. Slow release medicinal liquids and/or powders may be used, such as capsaicin, goldenseal, Echinacea, icy-hot compounds, combinations thereof and the like. Looking again to FIG. 16, the incision cover 10 is shown including a pad cover 12 attached to a securing tab 14 having a fastener 16 at the distal end thereof. In the middle of the incision cover 10, there is shown a super-absorbing polymer core 18 surrounded by a membrane material 20 on top and bottom.

In practice, the presently promoted incision cover, in its entirety, is submerged in water until the super-absorbing polymer has absorbed a desired amount of water and swollen to an acceptable dimension. Super-absorbing polymers are well known in the art and are conventionally used in diapers, feminine napkin products, and in other hygiene products for absorbing bodily fluids and liquids. Needless to say, the super-absorbing polymer which would be selected for this application would most advantageously be one that would absorb the most water in the least amount of time. The selection of a suitable super-absorbing polymer may be done by one of ordinary skill in the art without any undo experimentation. Nearly any super-absorbing polymer absorption rate would be suitable for this application, including those super-absorbing polymers which absorb from 100 times to 1,000 times their weight in water. However, it must be envisioned by those reading this patent application that any absorption rate would work. It would merely work slower or faster.

Referring now to FIG. 17, there is shown a new type of bandage for an incision cover being promoted with this present invention that is an incision cover generally denoted by the numeral 30, including a substrate 32 which is preferably a plastic substrate having an adhesive back for receiving the super-absorbing polymer membrane cover 34. Adhesive portions 36 may be at the proximal and distal end of the incision cover 30, although it is envisioned by the present inventor that such an adhesive may completely surround the membrane cover 34 if so desired. In essence, FIG. 17 illustrates a bandage of a conventional configuration, although instead of having a gauze core, there is a core membrane cover 34 that covers a super-absorbing polymer (seen hereinbelow in further figures).

FIG. 18 is an illustration of the cross section of the bandage of FIG. 17 taken along lines B-B of FIG. 17 and incision cover 30 is shown with a substrate 32 at the bottom, with a super-absorbing membrane cover 34 attached thereto over a super-absorbing polymer core 38. Core 38 may be made of the same materials as those described hereinabove with regards to FIGS. 15 and 16. All the same preferences and embodiments are incorporated into this figure as well. Again, there may be an optional perforated plastic cover covering the membrane cover 34 so that the incision cover 30 will not stick to an incision directly, and would still allow the relieving aspects of the super-absorbing polymer to be realized by the patient. In addition to the above-mentioned problems, there are continuing problems with medical procedures that involve edema, or swelling of extremities following surgeries and/or radiation treatments, for example with breast cancer causing lymphedema. Other edemas may occur in the legs, feet, hands and arms of patients after their surgeries or other treatments. It has been found by one of the present inventors that the swelling is greatly reduced by the utilization of the super-absorbing polymer core when covering the affected areas.

Looking next to FIG. 19, there is shown a lymphedema therapy device generally denoted by the numeral 40, which includes a super-absorbing polymer cover 42 surrounding a super-absorbing polymer layer or matrix 44 which can be either pulled up around the affected area, or may be fastened by any conventional means including zippers, Velcro®, hooks and eyes, or any other known fastener. Optionally, the lympedema device may also include an elastic compression fabric, such as those utilized by companies such as Jobst Corporation of North Carolina, or Carolan Corporation, also of North Carolina. The compression fabric may be rated from 10 millimeters mercury compression to over 100 millimeters mercury compression, such as is standard in the compression arts.

The present invention proposes the combination of the cooling gel of the super-absorbing polymer in combination with the compression fabric. This results in a device providing both cooling and compression effects at the same time. Hence, proposed is a pain and swelling reducing device which will compress the edema while also allowing for cooling it with the super-absorbing polymer.

FIG. 20 shows a similar device, an edema reduction device generally denoted by the numeral 50, including the super-absorbing polymer containing wrap 52, and also having fasteners 54 which may include the Velcro®, hook and eye, or zipper shown in the embodiment of FIG. 5. Such a device may also be worn under a cast in order to prevent itching and/or burning, and may be worn in combination with a splint or temporary cast, as is conventionally used in the medical industry of today. All of us remember the days when your school friend had a broken leg with a permanent plaster cast, shoving stretched out coat hangers down their cast in order to reach that itch way down in the cast. Today, conventional medicine utilizes more temporary cast materials, but the itching is still part of the recovery process. The super-absorbing polymer being proposed by the present invention alleviates such itching and burning, and helps the healing process greatly.

FIG. 21 shows a super-absorbing polymer containing pad 70 with a cover 72 to be utilized for general alleviation of pain, itching, burning, swelling, or any other medical condition which may be helped by the utilization of either warm or cool temperatures, including moist heat and moist cooling. Bed sores are alleviated by persons laying on such a pad, as pressure points are reduced. The pad 70 may be of any dimension, but is preferably from one foot by one and half feet in dimension to approximately the size of a human body to lay on a bed in order to prevent bed sores and the like. On the underside of device 70, there may be an optional plastic pad so that the bedding of the person laying on top of pad 70 will not become wet from the moisture which is then absorbed by the super-absorbing polymer core (not shown) and held within the super-absorbing polymer cover 72. In essence, a super-absorbing polymer core can be wetted and covered with a cover 72 and placed on a bed before a patient lies on top of it. The patient will experience the gel-like cushioning and the cooling effect of the super-absorbing polymer, unless the super-absorbing polymer has been heated, for instance in a microwave or a crock-pot, or any other heating device. There are so many uses for such a pad, that they cannot all be detailed in this patent application. However, some additional applications are noted in another patent application by some of the present inventors, U.S. Ser. No. 10/147,723, which is incorporated herein by reference.

FIG. 22 shows a fever reducing “suit” comprised of a number of our cooling devices to be used on various portions of the body, and the fever reducing suit is generally denoted by numeral 80. Of course any number of pieces may be utilized, and depending upon the patient which is experiencing the fever, there may be more or less pieces utilized. Each of the pieces is made similar to our other devices, as is shown in FIGS. 15 thru 20. The attachments to be used may, as described hereinabove, include Velcro®, elastics, adhesives, or any other suitable means of fastening the cooling device around various portions of the body. When the patient has a fever, they want to reduce that fever by cooling down with contacting our cooling device.

In the past, fever reduction has either been accomplished by prescribing aspirin or acetaminophen or dunking the patient in a bath of cool or tepid water. However, tests have shown that the fever reduction suit described herein works faster to reduce fevers than prior art methods.

Looking again to FIG. 22, there are shown proposed individual pieces for the fever reduction suit 80, including a headband 82 which may also be used as a neckband, and to be used in conjunction with a thoracic band 88. For the arms of the patient a set of fever reduction advices 84 and 86, respectively, are used for the upper and lower arms. Likewise, a diaper type device Number 94 may be utilized for cooling the central lower portion of the body. In order to cool the legs, a cooling device 90 may be used on the thigh, while a separate cooling device 92 may be utilized on the lower leg. As discussed above, any number of these devices may be utilized, or more devices which essentially would just be more of the cooling devices for locations otherwise on the body. All of the pads can be made utilizing the super-absorbing polymer core, and may also be fashioned as entire limb covers which can be wrapped around with an ace bandage. In other words, instead of individual leg portions 90 and 92, an entire boot may be created which is made with the super-absorbing material core, and may be adhered closer to the body by utilizing elastic bandages, such as is shown in FIG. 23.

Lastly, FIG. 23 illustrates yet another embodiment of the fever reducing suit made in accordance with the present invention, and includes the fever reduction boot generally denoted by numeral 100 and is made of a core material 102 being made of the super-absorbing polymer, and including an elastic band 104 around the top for bring the boot up around the lower calf or in any elongated embodiment, up around the crotch of the patient. An elastic band, optionally used, is denoted by numeral 106, and may be wrapped tightly in order to adjust the boot for various patients. Likewise, arms and gloves are also anticipated and embodied by the present invention, as well as a full thoracic covering (not shown).

Therefore, the present invention has provided a new configuration, method and numerous devices to utilize the present technology for cooling, wetting, and absorbing applications, along with fire deterrent applications. Although the present invention has been described above with respect to specific embodiments, it must be seen by one of ordinary skill in the art that there are many other applications for the multi-layer configuration of the present invention. This invention should not be limited by the described embodiments, rather it should only be limited by the appended claims.

1. A multi-layer cooling and wetting material structure adapted for absorbing many times its own weight in water for cooling applications for items, people and animals, comprising:
a super absorbent polymer impregnated material core where the super absorbing polymer is held in place rather than existing as loose crystals;
at least two opposing semi-permeable membranes adjacent to said super absorbing polymer core; and
at least two outer fabric layers for containing the super absorbing polymer core and semi-permeable membranes therein.

2. The material structure of claim 1, wherein the super absorbing polymer is a hydrophilic composition adapted to absorb water at a rate of from about 20 to about 10,000 times its weight of water.

3. The material structure of claim 1, wherein the super absorbing polymer crystals are finely ground from a mesh size of about 10,000 up to about 50 mesh size.

4. The material structure of claim 1, wherein the super absorbing polymer core includes particle sizes ranging from about 15 micrometers to about 0.25 centimeters.

5. The material structure of claim 1, further comprising the inclusion of powdered time-release fragrance powders within the core.

6. The material structure of claim 1, further comprising the inclusion of enzyme powders within the super absorbing polymer core to reduce odors and dirt.

7. The material structure of claim 1, wherein the material structure is incorporated into an article selected from the group consisting of a neck band, a cooling vest, a cooling kidney belt, a golf-type polo shirt, a visor cap, a beverage can cooler, a horse cooling blanket, a horse leg cooling device, a headband, and underarm shields.

8. A water wettable material structure to be used for fire deterrents, comprising:
a super absorbing polymer impregnated material core where the super absorbing polymer is held in place; and
at least two outer fabric layers for containing the super absorbing polymer after it has been wetted,
wherein the fire deterrents material is adapted for draping over a house, trees, lawn, and outbuildings surrounding the home, such that when a fire is detected, the homeowner can wet the material after it has been draped over the item to be deterred from fire and wetted to a sufficient degree such that when an impinging fire will not burn anything that is underneath the wetted material structure.

9. The water wettable structure of claim 8, wherein the multi-layer structure can swell up to a thickness of between about one-half inch and about 6 inches.

10. The water wettable structure of claim 8 may be multiple long strips having a dimension of from about 1 to about 2 feet wide and from about 30 to about 50 feet long, in order to be adapted to be draped over a house by a homeowner.

11. The water wettable structure of claim 8, wherein the super absorbing polymer includes crystals finely ground from a mesh size of about 10,000 up to about 50 mesh size.
